(19) United States
(12) Patent Application Publication
(10) Pub. No.: US 2009/0094143 A1
(43) Pub. Date: Apr. 9, 2009

(54) Gross Margin Tax Method

(75) Inventor: Reina Wiatt, Austin, TX (US)

Correspondence Address: REINA WIATT, 2127 MELRIDGE PL, AUSTIN, TX, 78704, US

(73) Assignee: Megladon Manufacturing Group, Ltd.

(21) Appl. No.: 11/867,851

(22) Filed: Oct. 5, 2007

(51) Int. Cl. G06Q 40/00

(52) U.S. Cl. 705/31

(57) ABSTRACT

A method for calculating the gross margin tax (GMT), for example, in a particular state. In an example embodiment, one or more new accounts are added to the income statement for a GMT taxable entity. These new accounts are accounts or items that are deductible under the GMT, but not necessarily under the federal tax.

### BACKGROUND AND SUMMARY OF THE INVENTION

The present application relates to a financial system, and more particularly to a method for preparing a calculation for gross margin taxes.

### DESCRIPTION OF BACKGROUND ART

The state of Texas recently passed a new tax called the Gross Margin Tax (GMT). This tax is new in the state of Texas, and takes effect beginning in 2008, based on the 2007 accounting period. The tax is for the privilege of doing business in the state, and is imposed on corporations, LLCs, professional associations, partnerships, limited partnerships, and others. It is noted that the tax is unique to Texas (TX), and there is no other tax like it in other states of the US. The tax, because it is unique, presents specific accounting problems that are typically addressed by cumbersome methods (described more fully below) that require all accounts to be analyzed at the transaction detail level. The time and cost to retroactively evaluate every Generally Accepted Accounting Principles (GAAP) transaction and most of the federal return adjustments at the end of the year is prohibitive and would likely result in incorrect data, and possibly costly return errors.

The tax is 1% (or less for wholesalers and retailers) as computed by a specific formula, described more fully below. Entities with gross receipts of $300,000 or less are exempt from the new GMT, but must still file the return. Hence, even if exempt, the accounting steps involved for taxable entities must still be taken even by exempt entities.

In summary, the taxable margin under the GMT equals the gross receipts less either the cost of goods sold or the compensation expense (not both). Gross receipts include revenues, dividends, interest, rents and royalties, and capital gains in TX. Returns, allowances, and bad debt expenses may be subtracted.

Cost of goods sold is only available as a deduction to an entity that owns the goods it sells. The deduction is not available to those in the services industry. All direct costs of acquiring or producing goods are included in the cost of goods sold, including labor. For example, these can include acquisition costs such as inbound transportation, component materials and materials consumed during production, etc. Production costs can, for example, include labor, storage, and handling. Other costs can include facilities and equipment costs (rental expenses, depreciation and amortization, repair), research and development, and others. Indirect or administrative costs allocable to acquiring or producing goods are also included, up to 4% of indirect or administrative overhead costs. This includes items such as data processing, security, financial planning costs, legal and accounting services, and some other general management costs.

Compensation expenses include gross wages and cash compensation to employees, officers, owners, partners, and directors, up to $300,000 per individual.

### PRIOR ART METHOD FOR CALCULATING THE TEXAS GMT

To calculate the GMT, an entity must start with its gross revenues, then subtract the greater of: cost of goods sold (for retailers/wholesalers only); or compensation expense. The greater of these two deductions yields a lower taxable margin. The margin cannot exceed 70% of total revenues. The tax rate is 1% (or less for wholesalers and retailers). Allowable credits are subtracted, and the remaining is the tax due. All accounts must be analyzed at the transaction detail level to assess several factors, such as whether the transaction is a TX or a non-TX transaction, whether the transaction is wholly or partly inclusive in the tax calculation, and whether the federal tax inclusions/exclusions are properly identifiable. Hence, the tax effectively requires a retroactive evaluation of every GAAP transaction and most of the federal return adjustments at the end of the year. This is costly in both time and expense, and places a substantial burden on businesses required to comply with the tax.

This “brute force” method of calculating the GMT requires the keeping of an additional account, namely, the GMT account which shows the deductions permitted for calculating the GMT (some of which are listed above). A new account for the GMT deductions is required because these deductions are different than those permitted for calculating federal income tax or franchise tax. In essence, the GMT requires a taxable entity to keep track of and aggregate a new set of its book entries that were not previously associated for the purposes of any single tax calculation. Hence, the new GMT tax imposes a new accounting and bookkeeping burden on those taxable entities, and also on many non-taxable or exempt entities, since they must still file the return to show they are exempt.

Gross Margin Tax Method

The present innovations include a method for calculating the gross margin tax (GMT), for example, in a particular state. In an example embodiment, one or more new accounts are added to the income statement for a GMT taxable entity. These new accounts are accounts or items that are deductible under the GMT, but not necessarily under the federal tax.

At least two codes are added to the income statement for a GMT taxable entity. These codes are preferably included for all items in the taxable entity's income statements. Using these codes, the need for keeping a separate set of books to calculate the GMT is obviated. New accounts are also added (some additional GAAP accounts, some entirely new accounts beyond the normal GAAP accounts). These new accounts are added in order to keep track of transactions necessary to the calculation of the GMT, and so that the debit and credit adjustment columns will total to the same amount.

The innovative method presented herein creates a seamless, proactive approach to sorting and calculating the financial data needed to calculate the GMT, thereby eliminating the need for the “brute force” method of retroactively evaluating each transaction (which is otherwise needed in order to calculate the GMT).

### BRIEF DESCRIPTION OF THE DRAWINGS

The disclosed inventions will be described with reference to the accompanying drawings, which show important sample embodiments of the invention and which are incorporated in the specification hereof by reference, wherein:

FIGS. 1A and 1B show an income statement for the example taxable entity, XYZ Partnership.

FIG. 2 shows a set of process steps for calculating the GMT, consistent with an embodiment of the present innovations.

### DETAILED DESCRIPTION OF THE PREFERRED EMBODIMENTS

The numerous innovative teachings of the present application will be described with particular reference to the presently preferred embodiment (by way of example, and not of limitation).

The present innovations include, in an example embodiment, the inclusion of new coding columns in an income statement for calculating GMT. New accounts, specific to the calculation of the GMT, are also added to the income statement. The addition of the coding columns and new accounts into the existing books makes calculation of the GMT possible without the need for keeping an additional set of books solely for the purpose of calculating the GMT.

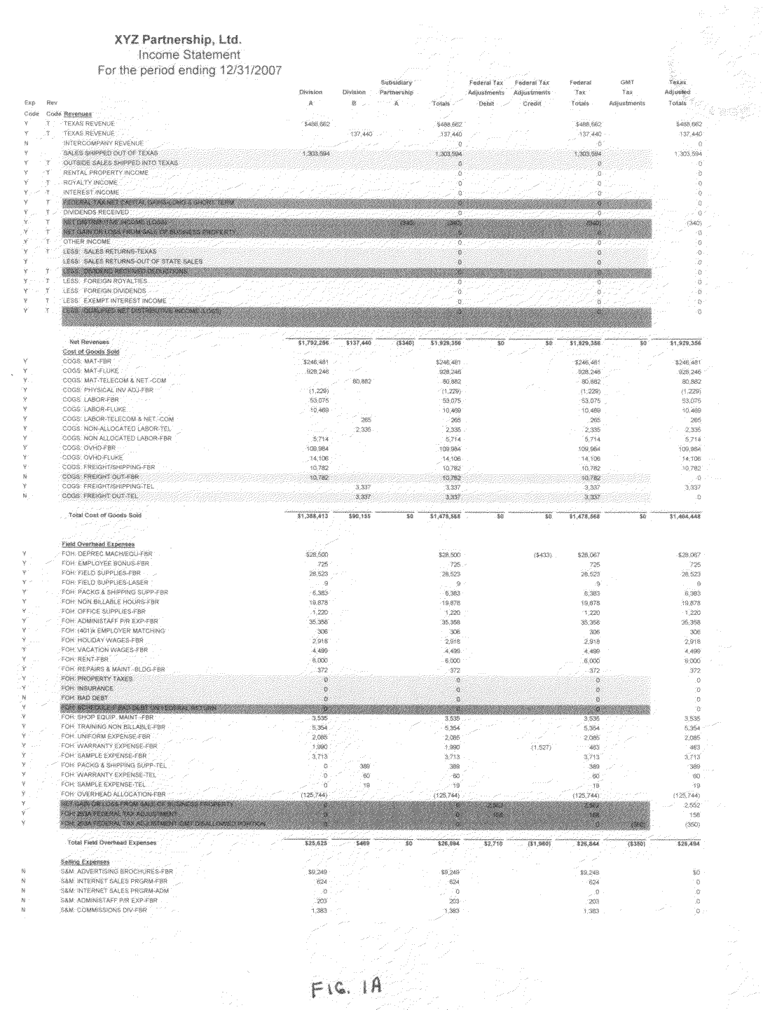

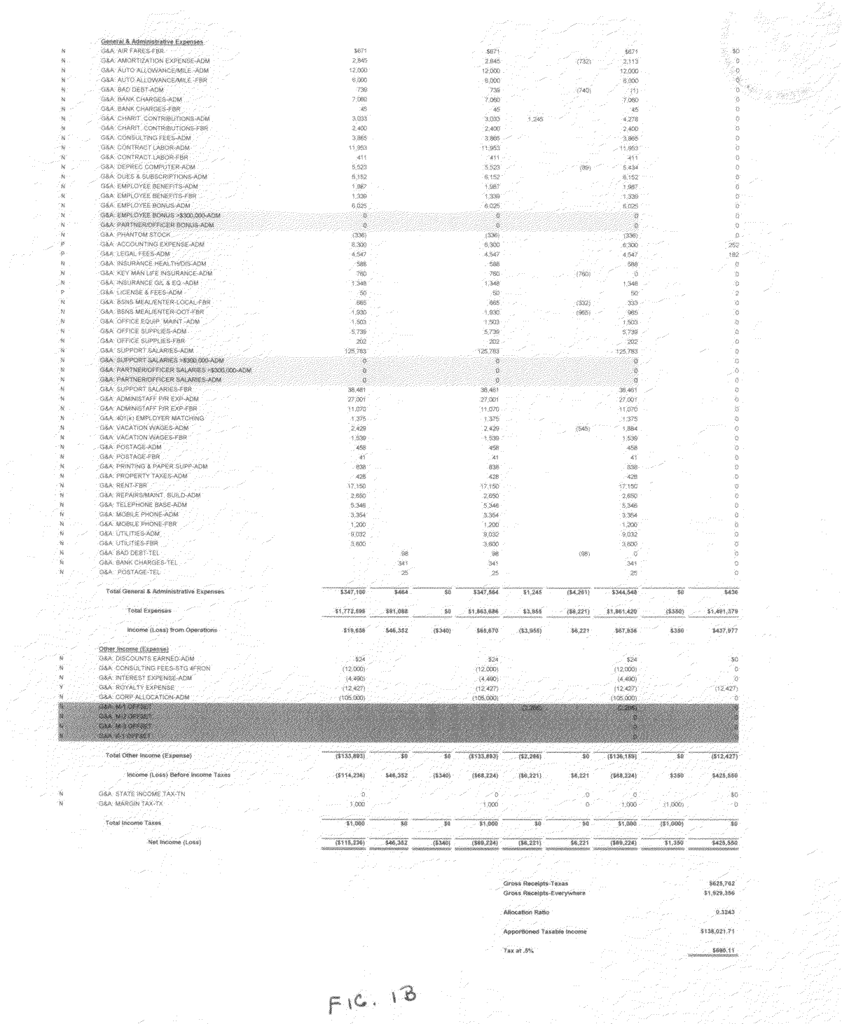

FIGS. 1A and 1B show an example income statement for a GMT taxable entity, called XYZ Partnership, Ltd. The income statement is for the period ending Dec. 31, 2007, and includes new coding columns specific to the calculation of the GMT, as described below.

All items in the income statement are coded with two columns, the Expense code column, and the Revenue code column.

The Expense code column indicates whether that item is deductible from the GMT liability or not. Codes are entered as a Y or N, indicating “yes” or “no”. If the item is coded Y, then its amount is included in the deductions for the GMT. Otherwise, the item is not deductible from the GMT.

For example, in the XYZ Partnership income statement, under Net Revenues: Cost of Goods Sold (COGS), most matters are indicated to be deductible, using the Y indicator in the EXP Code column. However, some items, such as the COGS: Freight Out-FBR and the COGS: Freight Out-Tel, are not deductible from the GMT, so they are coded N. Note that in the Texas Adjusted Totals column, the amounts coded Y are included in the total, while the items coded N are not included in the total.

It is noted that some items in the Expense column are coded with a P rather than Y or N. The items coded P indicate items that are partially includable in the GMT deduction. For example, under Total Selling Expenses: General and Administrative Expenses, the items G&A: Accounting Expense-ADM and G&A: Legal Fees-ADM are coded P. These items are included in the GMT deduction, but only at 4%. Hence, the total of the G&A: Accounting Expense-ADM is $6300, but only $252 of that (4%) is carried into the Texas Adjusted Totals column.

The second code or filter parses the accounts allocation factor applicability. Royalties, gains, net distributive income and the sales destination point have to be broken out between Texas and non-Texas activity in order to properly calculate the GMT, and this second code performs this type of filtering.

In some embodiments, a third filter whether an account balance is allowable for GMT purposes (also federal, since the current law states that income for federal tax purposes is the starting point for GMT return calculation). In preferred embodiments, a single filter is used to determine whether an item is allowable for GMT purposes, and also whether it is partially includable.

GAAP accounting workpapers, whether manual or software driven, use both debit and credit entries to adjust account totals. The total debits must equal the total credits before the accounting records can be finalized. To ensure that all of the federal tax and GMT adjustments are accounted for, the same methodology is employed in the present innovations.

For example, suppose the total M−1 adjustments to the GAAP net income for a given year resulted in a $25,000 increase in taxable income. The $25,000 is comprised of debits and credits netting out to that amount. Without an “M−1” account in place, the debits and credits would not balance and there is no mechanism to easily verify the accuracy of the adjusting entries.

FIGS. 1A and 1B also include two shaded markers. All shaded accounts are new accounts. These new accounts are added because they are necessary to calculate the GMT tax correctly. The lighter highlight indicates additional GAAP accounts such as Freight Out and Factory Overhead (FOH) Property Taxes. The GMT allows a portion of expenses (insurance, property taxes, etc.) typically classified as administrative expenses to be deducted when calculating the tax. Instead of a 4% deduction, 100$ of the apportioned expenses are deductible. Freight-out, which is normally included in manufacturing costs, is designated as a sales and marketing expense, and therefore is not deductible when computing the tax.

The darker highlight indicates federal tax and GMT accounts that are not used in GAAP, such as the 263A Disallowance and Schedule F Bad Debt accounts.

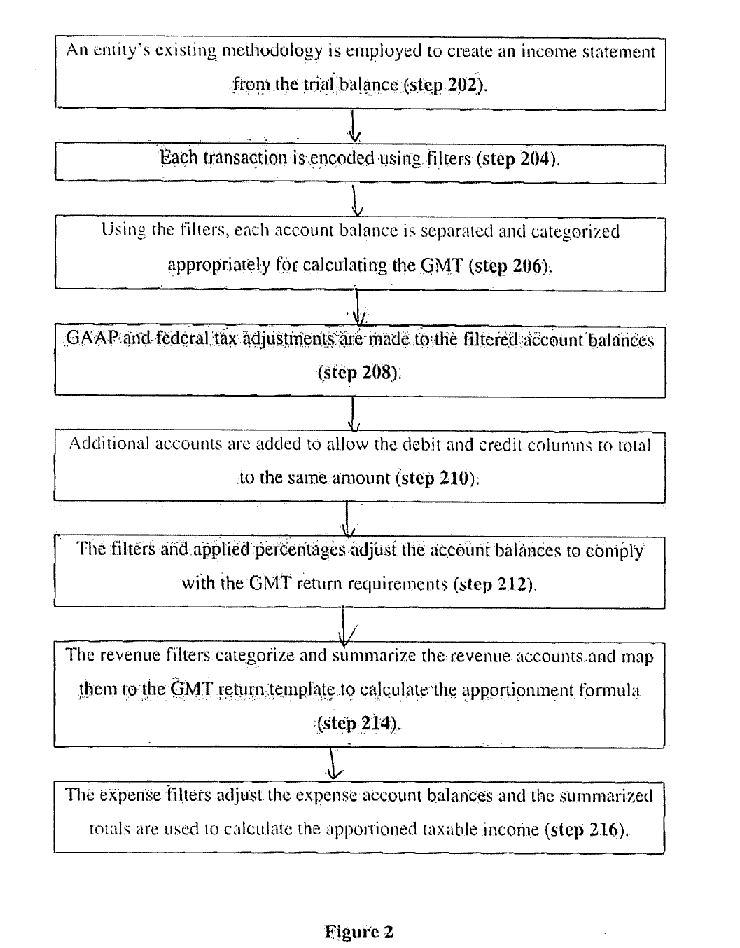

FIG. 2 shows a set of process steps for implementing an embodiment of the present innovations. In this example, a company's existing methodology is employed to create an income statement from the trial balance (step 202). Each transaction is encoded using filters (step 204). Using the filters, each account balance is separated and categorized appropriately for calculating the GMT (step 206). GAAP and federal tax adjustments are made to the filtered account balances (step 208). Additional accounts are added to allow the debit and credit columns to total to the same amount (step 210). The filters and applied percentages adjust the account balances to comply with the GMT return requirements (step 212). The revenue filters categorize and summarize the revenue accounts and map them to the GMT return template to calculate the apportionment formula (step 214). The expense filters adjust the expense account balances and the summarized totals are used to calculate the apportioned taxable income (step 216).

### MODIFICATIONS AND VARIATIONS

As will be recognized by those skilled in the art, the innovative concepts described in the present application can be modified and varied over a tremendous range of applications, and accordingly the scope of patented subject matter is not limited by any of the specific exemplary teachings given.

For example, though the examples presented herein mention that filters are added to a plurality of accounts, the exact number or determination of which accounts get filters can be varied. In preferred embodiments, all accounts are filtered, whether they are GAAP accounts or unique accounts. Other sets of filters can be implemented.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A method of preparing Gross Margin Tax return, comprising the steps of:
adding filters to a plurality of accounts for an income tax statement, wherein a first filter filters each account for GMT liability, and wherein a second filter filters for Texas versus non-Texas activity, and wherein a third filter adjusts certain G&A balances to 4% of the account total;
adding accounts to the list of GAAP accounts, wherein the added accounts permit transactions to be properly categorized to calculate the GMT, and the debit and credit columns of the income statement to total to the same amount;
generating a GMT return.

2. The method of claim 1, wherein the first and third filters are combined into a single filter with three possible entries.

3. The method of claim 1, wherein the filters added to the plurality of accounts are added to all accounts of the income tax statement.

4. A method of preparing a tax work paper schedule, comprising the steps of:
detailing the GAAP income statement for a business entity subject to a GMT;
detailing federal tax adjustments and GMT adjustments necessary to complete a GMT return by:
adding filters to a plurality of accounts for an income tax statement, wherein a first filter filters each account for GMT liability, and wherein a second filter filters for Texas versus non-Texas activity, and wherein a third filter adjusts certain G&A balances to 4% of the account total;
adding accounts to the list of GAAP accounts, wherein the added accounts permit transactions to be properly categorized to calculate the GMT, and the debit and credit columns of the income statement to total to the same amount;
generating a GMT return.

5. The method of claim 4, wherein the first and third filters are combined into a single filter with three possible results.

6. The method of claim 4, wherein the filters added to the plurality of accounts are added to all accounts of the income tax statement.

7. A method of filing a GMT return, comprising the steps of:
generating an income statement from a trial balance;
encoding a plurality of transactions using one or more filters;
making GAAP and federal tax adjustments to the filtered account balances;
adding a plurality of accounts so that the credit and credit columns total to be equal to one another;
applying the filters and applied percentages to adjust the account balances;
mapping the filtered accounts to a GMT return template to calculate the apportionment formula.

8. The method of claim 7, wherein the one or more filters include:
adding filters to a list of GAAP accounts for an income tax statement, wherein a first filter filters each account for GMT liability, and wherein a second filter filters for Texas versus non-Texas activity, and wherein a third filter adjusts certain G&A balances to 4% of the account total;
adding accounts to the list of GAAP accounts, wherein the added accounts permit transactions to be properly categorized to calculate the GMT, and the debit and credit columns of the income statement to total to the same amount.

9. The method of claim 8, wherein the first and third filters are combined into a single filter with three possible entries.
